(19) United States
(12) Patent Application Publication
(10) Pub. No.: US 2002/0192549 A1
(43) Pub. Date: Dec. 19, 2002

(54) Electrode composition, and lithium secondary battery

(75) Inventors: Satoshi Maruyama, Tokyo (JP); Mori Nagayama, Tokyo (JP); Atsuko Kosuda, Tokyo (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: TDK CORPORATION, Tokyo (JP)

(21) Appl. No.: 10/002,979

(22) Filed: Dec. 6, 2001

(30) Foreign Application Priority Data
Dec. 7, 2000 (JP) 2000-373033
Dec. 13, 2000 (JP) 2000-379034

(51) Int. Cl. H01M 4/62; H01M 4/52; H01M 10/40

(52) U.S. Cl. 429/217; 429/231.3; 429/337; 429/231.5; 429/231.6; 429/330

(57) ABSTRACT

One object of the invention is to provide an electrode composition that prevents capacity decreases that occurs when BF-based salts are used and a lithium secondary battery, and another object is to provide a lithium secondary battery having high discharge capacity even at low temperature with no risk of swelling even during storage. These objects are attained by the provision of an electrode composition containing a lithium fluoroborate-based salt in an electrolyte, wherein a poly(vinylidene fluoride) homopolymer is contained at least as a binder and a lactone is contained as an electrolyte solvent while the poly(vinylidene fluoride) homopolymer has been obtained by a emulsion polymerization process, and a lithium secondary battery using the same.

### BACKGROUND OF THE INVENTION

1. ART FIELD

The present invention relates to an electrode composition for secondary battery materials for lithium secondary batteries, etc., an improvement in or relating to electrolyte solutions using a non-aqueous solvent, and a secondary battery using the same.

2. BACKGROUND ART

Recent striking progresses of mobile apparatus and instruments lead to growing demands for batteries used as power sources for mobile apparatus and instruments, especially lithium ion batteries. With functional versatilities of mobile apparatus and instruments, the achievement of ever higher energy and incidental battery property improvements becomes a new target for the technical development to be attained. Among technical challenges of importance, there are:

(1) safety improvements (protection against overcharging, etc.),

(2) high-temperature storage improvements, and

(3) cycle performance improvements.

Improvements in high-temperature storage properties have already been achieved for some battery systems, for instance, lithium ion secondary batteries by making an appropriate selection from salts used therewith, especially LiPF₆, LiBF₄ or imides such as LiClO₄. One possible factor for the improvements could be the thermal stability of such salts. More recently, novel lithium salt compounds such as those set forth in JP-T 2000-60834, too, have been proposed and practically used.

Another possible factor could be the electrochemical stability of solvents used for electrolyte solutions and the content of water in the solvents, and applications of additives and various solvents are now under consideration.

Thus, various methods have been used for high-temperature storage purposes. In consideration of the overall balance of battery properties, however, it is still difficult to improve high-temperature storage properties while keeping other battery properties intact. As an example, this is explained with reference to using LiBF₄ as an electrolyte salt. This LiBF₄ (hereinafter BF for short) is lower in conductivity than but superior in thermal stability to LiPF₆ (PF for short). Accordingly, high-temperature storage properties, for instance, changes in the internal impedance of batteries as detected by the measurement of alternate currents upon storage become lower as compared when PF systems are used. However, low conductivity causes battery capacity to become lower than that of PF system batteries. In other words, when BF is used as an electrolyte salt, it is required to control the composition of an electrolyte solution solvent in view of such considerations and techniques incidental thereto are available as well. Still, the problem that the capacity is lower than that of PF systems remains unsolved.

For recent, more advanced mobile apparatus and instruments for which higher energy densities are needed, it is required to improve the properties of BF systems especially when batteries must have high capacities (when the amount of battery electrode active materials loaded is increased), in particular keep capacity reductions at low levels.

More recently, batteries housed in flexible aluminum laminated films have been introduced so as to achieve ever higher capacities.

A problem with the aluminum laminated film is that as gases are produced from within a battery after the battery has been assembled, the battery swells. This problem may be surmountable by using γ-butyrolactone for its electrolyte solution as set forth typically in JP-A 2000-236868.

On the other hand, a problem with lithium secondary batteries is that their capacity becomes insufficient at low temperature. Some solutions to this problem are disclosed typically in JP-A's 06-290809 and 08-138738. However, these are chiefly directed to improvements in electrolyte solution compositions; it is still more difficult to improve the low-temperature properties on the premise that γ-butyrolactone should be used for prevention of battery swelling.

### SUMMARY OF THE INVENTION

An object of the invention is to prevent the capacity of a battery from decrease when the aforesaid BF salts are used therefor.

Another object of the invention to provide a solution to the problem with the BF system especially when electrodes are designed to have high energy densities.

A more specific object of the invention is to provide a technique by which, when PVDF (polyvinylidene fluoride) is used as an electrode binder, a cyclic carbonate, especially EC (ethylene carbonate) is used as an electrolyte solution solvent, γ-butyrolactone is used as the second component for forming a gelled solid electrolyte and PVDF synthesized through a certain process is used as a binder for the aforesaid BF salt serving as a salt, capacity decreases can be much more reduced than ever before in spite of using the BF salt.

Yet another object of the invention is to provide a thin lithium secondary battery with an element added to a cathode active substance, wherein its low-temperature properties are improved by prevention of outgassing from battery electrodes during storage at high temperature.

These objects are achieved by the embodiments recited below.

(1) An electrode composition containing a lithium fluoroborate-based salt in an electrolyte, wherein:

a poly(vinylidene fluoride) homopolymer is contained at least as a binder and a lactone is contained as an electrolyte solvent,

said poly(vinylidene fluoride) homopolymer being obtained by a emulsion polymerization process.

(2) The electrode composition according to (1) above, wherein said poly(vinylidene fluoride) homopolymer has a molecular weight of 50,000 or higher and a degree of crystallinity of 30% or greater, and

a solvent for an electrolyte solution further contains a cyclic carbonate provided that the volume ratio of said cyclic carbonate and said lactone is in the range of 3/7 to 1/9 as calculated on an ethylene carbonate-to-γ-butyrolactone basis.

(3) A lithium secondary battery, which comprises an electrode composition as recited in (1) or (2) above.

(4) The lithium secondary battery according to (3) above, wherein at least the poly(vinylidene fluoride) homopolymer, lactone and lithium fluoroborate-based salt are contained as solid electrolyte components.

(5) The lithium secondary battery according to (3) or (4) above, wherein a lithium-containing composite oxide comprising lithium cobalt oxide and a subordinate component element M, where M is a transition or typical metal element exclusive of Li and Co, in an amount of 0.001 to 2 at % relative to cobalt in the lithium cobalt oxide is contained as a cathode active substance, and 60 to 95% by volume of γ-butyrolactone is contained as an electrolyte solvent.

(6) The lithium secondary batter according to (5) above, wherein said subordinate component element is one or two or more of Ti, Nb, Sn and Mg.

(7) A lithium secondary battery, wherein:

a cathode, an anode and an electrolyte are encased in a housing,

a lithium-containing composite oxide comprising lithium cobalt oxide and a subordinate component element M, where M is a transition or typical metal element exclusive of Li and Co, in an amount of 0.001 to 2 at % relative to cobalt in the lithium cobalt oxide is contained as a cathode active substance,

60 to 95% by volume of γ-butyrolactone is contained as an electrolyte solvent, and

said housing has a thickness of 0.3 mm or smaller.

(8) The lithium secondary battery according to (7) above, wherein said subordinate component element is one or two or more of Ti, Nb, Sn and Mg.

### WHAT IS ACHIEVED BY THE INVENTION

The inventor has made studies with a chief view to improving the properties of the BF system especially when batteries are allowed to have higher capacities, in particular reducing capacity decreases as much as possible. In other words, the present invention has been accomplished for the purpose of providing a solution to such problems with the BF system. The battery system disclosed herein may also be applied to systems using gelled solid electrolytes that have attracted attention in recent years. With the inventive battery, it is possible to achieve large-current discharging unlike batteries using an organic solid electrolyte wherein, as taught by past research, lithium ions conduct through a polymeric medium.

Setting a goal of optimizing an electrode arrangement to provide rapid diffusion of lithium ions through a battery, thereby attaining the aforesaid objects, the inventor has made extensive studies, and especially a close study of the type of possible binders.

As a result, the inventor has found out that a serendipitous binder has a specific influence on the properties of BF system batteries.

That is, the binder used herein is based on the PVDF system; however, it must have been synthesized by emulsion polymerization. The synthesis technique for the PVDF used herein is already disclosed in JP-A 08-250127. However, never until now is there any specific report on what relations this PVDF has to battery properties in general, and on battery properties especially when the BF salt is used.

### EXPLANATION OF THE PREFERRED EMBODIMENTS

First Embodiment

According to the first embodiment of the invention, there is provided an electrode composition containing a lithium fluoroborate-based salt in an electrolyte, wherein a poly(vinylidene fluoride) homopolymer is contained at least as a binder and γ-butyrolactone is contained as an electrolyte solvent. The poly(vinylidene fluoride) homopolymer has been obtained by a emulsion polymerization process.

According to the first embodiment of the invention, there is also provided a lithium secondary battery comprising the aforesaid electrode composition.

According to the invention, only when this poly(vinylidene fluoride) homopolymer (hereinafter PVDF for short) is used as the binder, the capacity decreases of the fluoroborate lithium-based system (BF system for short) can be reduced. When PVDFs obtained by other synthesis processes are used, such effects are not found at all. Thus, the use of PVDF provides an extremely effective means for making the energy density of the electrode high. Although this mechanism has yet to be clarified, possible explanations could be that active points in PVDF interact with the BF salt in the electrode to reduce resistance, and improvements in the swelling capability due to a crystallinity difference between resins ensure smooth diffusion of lithium with the result that the battery capacity decreases can reduce by half those found so far in the art.

The use of emulsion polymerization processes is disclosed in JP-A 08-250127, etc. According to a typical emulsion polymerization process, a perhaloolefin, i.e., a monomer that provides curing sites, is subjected under pressure and agitation to emulsion polymerization in the presence of a radical initiator, in substantially the absence of oxygen, and in the presence of an iodine or bromine compound, preferably a diiodine compound in an aqueous medium.

One advantage of the homopolymer obtained by the emulsion polymerization process is that it has very high purity or contains impurities in trace amounts of the order of ppb (parts by billion).

The homopolymer obtained by this emulsion polymerization process has a degree of crystallinity of 30% or higher, especially about 35 to 55%, and a molecular weight of preferably 50,000 or higher, more preferably 100,000 to 140,000.

Preferably for the electrode, a composition comprising an electrode active substance and a binder optionally with a conducting aid is used.

For an anode it is preferable to use an anode active substance such as a carbonaceous material, a lithium metal, a lithium alloy or an oxide material, and for a cathode it is preferable to use a cathode active substance such as an oxide or carbonaceous material capable of intercalating or deintercalating lithium ions. By using such electrodes, a lithium secondary battery having good enough properties can be obtained.

For the carbonaceous material used as the electrode active substance, for instance, an appropriate selection may be made from mesocarbon microbeads (MCMB), natural or man-made graphites, resin-fired carbonaceous materials, carbon blacks and carbon fibers, which are all used in powdery forms. Among others, preference is given to graphite having an average particle diameter of 1 to 30 μm, especially 5 to 25 μm. Too small average particle diameters would make charge/discharge cycle life short, and cause capacities to vary largely from battery to battery. Too large average particle diameters would lead to large capacity variations, resulting in an average capacity decrease. Why large capacity variations are caused with large average particle diameters could be due to fluctuations of contact of graphite with a collector or contacts of graphite particles with one another.

For the oxide capable of intercalating and deintercalating lithium ions, preference is given to lithium-containing composite oxides, for instance, LiCoO₂, LiMn₂O₄, LiNiO₂ and LiV₂O₄. Preferably, powders of these oxides should have an average particle diameter of the order of 1 to 40 μm.

If required, conducting aids may be added to the electrode. For instance, graphites, carbon blacks, carbon fibers, and metals such as nickel, aluminum, copper and silver are used, although graphites and carbon blacks are particularly preferred.

Referring to electrode composition, the cathode should preferably have an active substance/conducting aid/binder ratio in the range of 80-94:2-8:2-18 by weight, and the anode should preferably have an active substance/conducting aid/binder ratio in the range of 70-97:0-25:3-10.

For electrode fabrication, the active substance and binder, optionally with the conductive aid, are first dispersed in a binder solution to prepare a coating solution.

Then, this coating solution is coated on a collector. Appropriately but not exclusively, the coating means should be determined depending on the material and shape of the collector used. In general, various processes such as metal mask printing, electrostatic coating, dip coating, spray coating, roll coating, doctor blade coating, gravure coating and screen printing are used. If required, calendering may subsequently be carried out, using a flat plate press, a calender roll or the like.

The collector used should be appropriately chosen from ordinary collectors depending on the shape of devices for which batteries are used, how to place collectors in cases, etc. In general, aluminum or the like is used for the cathode, and copper, nickel or the like is used for the anode. It is here noted that the collector is usually formed of a metal foil, a metal mesh or the like. While the metal mesh is lower than the metal foil in terms of contact resistance with electrodes, it is understood that low enough contact resistance is obtainable even with the metal foil.

Finally, the solvent is evaporated off to finish up an electrode. The coating thickness should preferably be of the order of 50 to 400 μm.

Lithium Secondary Battery

A lithium battery, whose structure is not critical to the invention, is usually constructed of a cathode, an anode and a separator, and is used in the form of laminated batteries, cylindrical batteries and so on.

The cathode, separator and anode are laminated together in this order, and then compressed together to obtain a battery body.

An electrolyte solution to be impregnated in the separate is usually comprised of an electrolyte salt and a solvent. For the electrolyte salt, for instance, lithium salts such as LiBF₄, LiPF₆, LiAsF₆, LiSO₃CF₃, LiClO₄ and LiN(SO₂CF₃)₂ may be used. In the invention, however, lithium fluoroborates such as LiBF₄ are used.

For the solvent for the electrolyte solution, any desired solvent may be used without restriction, provided that it should have favorable compatibility with electrolyte salts. Preferable for lithium batteries, etc., however, are polar organic solvents that do not decompose even at high operating voltages, for instance, carbonates such as ethylene carbonate (abbreviated as EC), propylene carbonate (PC), butylenes carbonate, dimethyl carbonate (DMC), diethyl carbonate and ethylmethyl carbonate, cyclic ethers such as tetrahydrofuran (THF) and 2-methyltetrahydrofuran, cyclic ethers such as 1,3-dioxolane, 4-methyldioxolane, lactones such as γ-butyrolactone and sulforanes.

According to the invention, the solvent for the electrolyte solution should contain at least a lactone such as γ-butyrolactone. This lactone such as γ-butyrolactone should preferably be used in combination with the aforesaid solvents, especially the cyclic carbonate such as EC. The volume ratio between the cyclic carbonate and the lactone should preferably be in the range of 3/7 to 1/9, especially 1/3 to 3/17, as calculated on an ethylene carbonate-to-γ-butrolactone basis.

In the case where the electrolyte solution is made up of a solvent and an electrolyte salt, the concentration of the electrolyte salt should preferably be in the range of 0.3 to 5 mol/l. Usually at around 0.8 to 2.5 mol/l, the highest ion conductivity is found.

A solid electrolyte or separator sheet that forms the separator should preferably be formed of the aforesaid poly(vinylidene fluoride) homopolymer, especially one produced by the emulsion polymerization process.

A microporous film for the solid electrolyte used herein should preferably be formed by the following wet phase separation process.

In this wet phase separation process, a film is formed by solution casting while phase separation takes place in a solution. To be specific, a polymer providing a microporous film is dissolved in a solvent capable of solubilizing this polymer, and the resulting film-formation solution is then uniformly coated on a support such as a metal or plastic film to form a film thereon. After this, the film-formation solution cast in a film form is introduced into a solution called a solidifying bath, wherein a microporous film is obtained through phase separation. Alternatively, the film-formation solution may be coated in the solidifying bath.

To improve the adhesion between the aforesaid microporous film and the electrode, adhesives may be used. For instance, polyolefinic adhesives such as Unistall (Mitsui Chemical Industries, Ltd.), SBR (Nippon Zeon Co., Ltd.), Aquatex (Chuo Rika Co., Ltd.) and Adcoat (Morton Co., Ltd.) are usable, although Aquatex or the like is most preferred.

The bonding agent is dissolved or dispersed in water or an organic solvent such as toluene, and the resulting solution or dispersion is deposited and fixed onto the microporous film by spreading, coating or the like.

The microporous film should have a porosity of 50% or higher, preferably 50 to 90%, more preferably 70 to 80% and a pore diameter in the range of 0.02 μm to 2 μm, preferably 0.02 μm to 1 μm, more preferably 0.04 μm to 0.8 μm, even more preferably 0.1 μm to 0.8 μm, and most preferably 0.1 μm to 0.6 μm. The microporous film should have a thickness of preferably 20 to 80 μm, and more preferably 25 to 45 μm.

The microporous film should preferably be formed of a material having a melting point of preferably 150° C. or higher, especially 160 to 170° C. and a heat of melting of preferably 30 J/g or greater, especially 40 to 60 J/g.

For the separator, still other gelled polymeric materials may also be used. For instance:

(1) polyalkylene oxides such as polyethylene oxide and polypropylene oxide,

(2) copolymers of ethylene oxide and acrylates,

(3) copolymers of ethylene oxide and glycyl ethers,

(4) copolymers of ethylene oxide, glycyl ethers and allylglycyl ethers,

(5) polyacrylates,

(6) polyacrylonitriles,

(7) fluoropolymers such as polyvinylidene fluoride, vinylidene fluoride-hexafluoropropylene copolymers, vinylidene fluoride-ethylene chloride trifluoride copolymers, vinylidene fluoride-hexafluoropropylene fluororubber, and vinylidene fluoride-tetrafluoroethylene-hexapropylene fluororubber.

The gelled polymer may be mixed with the electrolyte solution or coated on the separator. Moreover, if an initiator is used, the gelled polymer may be crosslinked together by means of ultraviolet rays, EB, heat or the like.

The solid electrolyte should preferably have a thickness of 5 to 100 μm, preferably 5 to 60 μm, and especially 10 to 40 μm. The solid electrolyte according to the invention has so high strength that it can have a small thickness. The solid electrolyte according to the invention can be made thinner than a conventional gel electrolyte that cannot practically have a thickness of 60 μm or below, and than a separator (of usually 25 mm in thickness) used with a solution type lithium ion battery. It is thus possible to achieve a thin yet large-area battery, i.e., a sheet form of battery that is one advantage of using the solid electrolyte.

Further, the separator may be formed of one or two or more of polyolefins such as polyethylene and polypropylene (when two or more are used, the film is of a multilayered structure), polyesters such as polyethylene terephthalate, thermoplastic fluororesins such as ethylene-tetrafluoroethylene copolymers, and celluloses. Furthermore, microporous films, woven fabrics and unwoven fabrics may be used, which have an air permeability of the order of 5 to 2,000 seconds/100 cc as measured according to the JIS-P8117 method and a thickness of the order of 5 to 100 μm.

A housing bag is formed of a laminated film in which heat-adhesive resin layers of polyolefinic resins such as polypropylene and polyethylene or heat-resistant polyester resin layers are laminated on both surfaces of an aluminum or other metal layer. The housing bag is formed with one side kept open by thermally bonding two laminated films together in such a way that heat-adhesive resin layers at the end faces of three sides thereof are thermally bonded together, thereby forming a first sealing portion. Alternatively, one laminated film is folded back so that the end faces of both sides are thermally bonded together to form a seal.

To ensure insulation between the metal foil forming the laminated film and a leading terminal, it is preferable to use a laminated film having a multilayered structure comprising, in order from its innermost side, a heat-adhesive resin layer/polyester resin layer/metal foil/polyester resin layer. By use of such a laminated film, it is possible to ensure a certain distance and so insulation between the leading terminal and the metal foil in the housing bag, because the high-melting polyester resin layer remains unfused during heat-bonding. Accordingly, the polyester resin layer in the laminated film should preferably have a thickness of the order of 5 to 100 μm.

Second Embodiment

According to the second embodiment of the invention, there is provided a lithium secondary battery comprising a housing with a cathode, an anode and an electrolyte encased therein, wherein a cathode active substance contains a lithium-containing composite oxide comprising lithium cobalt oxide and a subordinate component element M, where M represents a transition or typical metal exclusive of Li and Co, in an amount of 0.001 to 2 at % relative to cobalt in the lithium cobalt oxide and a solvent for an electrolyte contains 60 to 95% by volume of γ-butyrolactone, said housing having a thickness of 0.3 mm or smaller.

With this embodiment, it is possible to provide a lithium secondary battery having satisfactory low-temperature properties with no outgassing even at high temperature. Even when a thin film form of housing is used, any swelling of the housing can be prevented.

In the lithium secondary battery according to the second embodiment, the cathode is formed of a mixture comprising a cathode active substance, a conducting aid such as graphite and a binder such as polyvinylidene fluoride. The conducting aid is the same as in the aforesaid first embodiment.

For the cathode active substance, lithium cobalt oxide (LiCoO₂) is used together with some amount of the subordinate component element. The subordinate component element may be either a typical element or a transition metal. Preferably, it is preferable to use one or two or more elements selected from Ti, Nb, Sn and Mg, and especially Ti and/or Nb. As already known, the element or elements have some contribution to improvements in temperature properties.

The total content of the subordinate component element M to Co in the lithium cobalt oxide should preferably be in the range of 0.001 to 2 at %, especially 0.01 to 1 at %, and more preferably 0.1 to 0.01 at %. When the content of the subordinate component exceeds this upper limit, capacity decreases occur, and with too little it is difficult to obtain any effect on improvements in low-temperature properties.

Alternatively, a part of Co may have been substituted by the subordinate component. Preferably, the cathode active substance is given by the following composition formula:

LiCo₁₋ₓMₓO₂

Here x=0.00001 to 0.02, and M represents a transition or typical metal element exclusive of Li and Co.

Ti, Nb, Sn and Mg are preferable for the substituent element M, although Ti and Nb are most preferred. These elements may be used alone or a part of Co may be substituted by two or more thereof. When two or more elements are used, they may be used in any desired combinations with the proviso that Co is substituted within the aforesaid total amount of substitution.

Usually, the anode comprises a carbonaceous material, a conducting aid and a binder. The conducting aid is the same as in the first embodiment.

The carbonaceous material used herein, for instance, includes man-made graphite, natural graphite, pyrolytic carbon, cokes, fired resins, mesophase spheres and mesophase pitch.

The binder used herein, for instance, include styrene -butadiene latex (SBR), carboxymethyl cellulose (CMC), polytetrafluoroethylene (PTFE), polyvinylidene fluoride (PVDF), ethylene-propylene-diene copolymers (EPDM), nitrile-butadiene rubber (NBR), vinylidene fluoride-hexafluoropropylene copolymers, vinylidene fluoride-hexafluoropropylene-tetrafluoroethylene terpolymers, polytrifluoroethylene (PTrFE), vinylidene fluoride-trifluoroethylene copolymers, and vinylidene fluoride-tetrafluoroethylene copolymers.

Electrode production is the same as in the aforesaid first embodiment.

In the second embodiment, the non-aqueous electrolyte solution has a composition wherein an electrolyte is dissolved in a non-aqueous solvent comprising a mixed solvent that contains as a main component 60 to 95% by volume, preferably 70 to 90% by volume, especially 75 to 85% by volume of γ-butyrolactone (abbreviated as γ-BL) in a solvent component and further contains at least a solvent selected from a chain carbonate, a cyclic carbonate, a chain ester, etc. When the composition ratio of γ-butyrolactone in the solvent departs from the range of 60 to 95% by volume, the formation of film on the surface of the carbonaceous material forming the electrode during initial charging becomes insufficient, resulting in a battery capacity decrease.

In the second embodiment, a sheet form of film having a thickness of 0.3 mm or smaller, especially 0.15 mm or smaller is used for the battery housing, in which the cathode, anode and separator are located. It is here noted that the lower limit to the thickness of the housing is usually about 0.03 mm although the invention is not particularly limited thereto. This battery is tightly sealed in a vacuum-sealed state.

In the second embodiment, the housing is made up of a flexible film. By using the flexible film and evacuating the interior of the battery to a vacuum, the film is brought into close contact with the battery electrode. It is thus possible to fabricate a thin yet small-sized battery. While any limitation is not imposed on the structure of the film, it is preferable to use an aluminum laminated film with a resin layer inserted through it.

The housing formed of the flexible film makes for battery size reductions because the battery can be made thin. However, a problem with this housing is that its softness causes the battery to swell out even upon slight outgassing therefrom.

The cathode used in the second embodiment is superior in low-temperature properties to ordinary lithium cobalt oxides; however, the high activity of the electrode surface offers a problem that when, for instance, the battery is stored in a full-charged state at high temperature, the cathode reacts with the electrolyte to produce gases.

For this reason, a small thin battery has the demerit of being unable to use any active substance of higher performance. As compared with dimethyl carbonate (DMC), methylethyl carbonate (MEC) and diethyl carbonate (DEC) often used with lithium secondary batteries usually encased in housing cans, the γ-butyrolactone used herein is less susceptible to oxidation and outgassing during high-temperature storage in a full-charged state. It is thus possible to use an active substance of higher performance even for batteries comprising housings formed of films that are thinner and softer than housing can materials that are relatively hard and less susceptible to deformation and, hence, fabricate small-sized yet high-performance batteries.

The second embodiment of the invention produces excellent effects even when applied by itself to a lithium secondary battery. It is understood, however, that this embodiment may be combined with the aforesaid first embodiment with synergistic effects which would enable more excellent lithium secondary batteries to be obtained.

### EXAMPLES

Lithium cobalt oxide, etc. were used for the cathode active substance, and graphite-based materials for the anode active substance. Materials obtained by the carbonization of organic materials, too, may be used for the anode although their properties are different than those of the graphite materials.

### Example A-1

Lithium cobalt oxide was used as the electrode active substance. For electrode preparation, various processes such as those mentioned above may be used. In this case, the following PVDF polymer was used as the binder.

PVDF Elf.Atochem Co., Ltd. (Atofina Co., Ltd.) Kynar 741

This PVDF was prepared by the emulsion polymerization process. With this binder, the electrode was prepared. In this example, a gelled solid electrolyte was used as the electrolyte. This gelled solid electrolyte was synthesized and prepared according to the process set forth in JP-A 11-276298.

More specifically, LiCoO₂ was used as the cathode active substance, acetylene black as the conducting aid, and PVDF Kynar 741 as the binder.

These feeds were weighed in such a way as to give a ratio of LiCoO₂:acetylene black:PVDF=83:6:11 by mass. Then, acetone was added in such a way as to give a ratio of acetone:PVDF=9:1 by mass. These were mixed together at room temperature to obtain a cathode slurry.

On the other hand, mesocarbon microbeads (MCMB) were used as the anode active substance, and acetylene black as the conducting aid.

These feeds were weighed in such a way as to give a ratio of MCMB:acetylene black:PVDF=85:3:12 by mass. Then, acetone was added in such a way as to give a ratio of acetone:PVDF=9:1 by mass. These were mixed together at room temperature to obtain an anode slurry.

The thus obtained cathode and anode slurries were each coated by a doctor blade process on a PET film, and the acetone was then evaporated off at room temperature to obtain a sheet.

The following materials were used to prepare a microporous film for the electrolyte film, which was then used to obtain a solid electrolyte.

Twenty (20) parts by weight of polyvinylidene fluoride (Kynar 761 made by Elf-Atochem Co., Ltd.) were dissolved in a mixed solution comprising 40 parts by weight of dimethylacetamide and 40 parts by weight of dioxane, and the resulting solution was then cast by a doctor blade process on a glass sheet at a thickness of 200 μm.

Immediately after the casting, the glass sheet was dipped in a solidifying bath comprising 80 parts by weight of dioxane and 20 parts by weight of water for 10 minutes for solidification, following which the glass sheet was washed in a water stream for 30 minutes, and then dried at 60° C. for 1 hour, thereby obtaining a microporous film having a thickness of 50 μm and comprising a poly(vinylidene fluoride) homopolymer.

The thus obtained microporous film was found to have a porosity of 70% and a pore diameter of 0.2 μm.

To give adhesion to the surface of the aforesaid microporous film, it is acceptable to deposit a polyolefinic material thereon by spraying or the like.

The solid electrolyte, cathode and anode were each cut to given size, and the resultant sheets were heat-laminated together at 130 to 160° C. Then, an aluminum grid with a conductive adhesive coated ahead thereon as a collector was heat-laminated on the cathode while a copper grid with a conductive adhesive coated ahead thereof as a collector was heat-laminated on the anode.

Subsequently, the battery assembly was impregnated with an electrolyte comprising 1M LiBF₄/EC+γ-butyrolactone (EC:γ-butyrolactone=2:8 by volume), and then sealed in an aluminum laminated pack to obtain a lithium secondary battery.

The thus assembled battery was measured for its post-charging capacity on the basis of the capacity of a previously fabricated PF system battery. This PF system battery was the same as disclosed with reference to the BF system battery in Example A-1 except the following point.

Electrolyte solution composition EC:DEC=3:7

### Comparative Example A-1

In this comparative example, PVDF KF1000 was used for the binder. This was prepared by suspension polymerization. Otherwise, Example A-1 was followed. By the same process as in Example A-1, a battery was fabricated and measured for its capacity.

### Example A-2

A battery was obtained in the same manner as in Example A-1 with the exception that the electrolyte solution composition was changed to EC:γ-butyrolactone=7:2.

### Comparative Example A-2

In this comparative example, a battery was obtained in the same manner as in Example A-1 with the exception that the electrolyte solution composition was changed to EC:DEC=3:7.

The results of these examples were summarized in Table 1. The rate of capacity decreases shown in Table 1 provides an indication of to what degree the initial capacity decreases from the reference capacity of the PF system battery.

TABLE 1

| Sample (%) | Rate of Capacity Decrease |
|---|---|
| Example 1 | 4.5 |
| Example 2 | 6.7 |
| Comp. Ex. 1 | 12 |
| Comp. Ex. 2 | 14 |

As can be seen from Table 1, Examples A-1 and A-2 are more reduced than Comp. Examples A-1 and A-2 in terms of the rate of capacity decreases. This is because γ-butyrolactone and PVDF polymer are used as the gelled solid electrolyte-forming elements and the PVDF polymer shown in Example A-1 is used as the electrode binder.

Such effects cannot be obtained with no coexistence of the gelled solid electrolyte-forming elements and the binder. While the batteries using the gelled solid electrolyte were herein assembled, it is understood that the coexistence of the aforesaid PVDF and γ-butyrolactone would also result in the achievement of similar effects in conventional solution type batteries.

### Example B-1

A polymer substance PVDF (Kynar 761A made by Elf-Atochem Co., Ltd.), an electrolyte wherein LiBF₄ was dissolved at a concentration of 2M in a solvent comprising ethylene carbonate:γ-butyrolactone=2:8 by volume and a solvent acetone were mixed together in such a way as to give a polymer substance:electrolyte:solvent ratio=3:7:20, thereby preparing a first solution.

A cathode active substance LiCo_{0.999}Nb_{0.001}O₂ and a conducting aid acetylene black were dispersed in the first solution in such a way as to give a first solution:active substance:conducting aid=2:7.5:1.2 by weight, thereby obtaining a cathode slurry.

A second solution was prepared as in the aforesaid first solution with the exception that the polymer substance:electrolyte:solvent ratio was changed to 3:7:5. An anode active substance graphite was dispersed in this second solution in such a way as to give a second solution:active substance ratio=2:1 by weight, thereby obtaining an anode slurry.

Using the aforesaid first solution, cathode slurry and anode slurry, a group of electrodes comprising a laminate of cathode-gelled solid electrolyte-anode-gelled solid electrolyte-cathode . . . was prepared. This was encased in a sheet form of housing (an aluminum laminated pack having a thickness of 100 μm), and the housing was sealed up by means of a sealer. Electrode size was 30 mm ×40 mm.

The thus assembled battery was charged and discharged at 25° C. and a cutoff of 4.2 to 3.0 V, 1.0 C for the measurement of its capacity, and then measured for its specific capacity at −20° C. After placed in a full-charged state of 4.2 V, the battery was loaded in an oven of 90° C. to measure changes in the battery thickness.

### Example B-2

A battery was assembled as in Example B-1 for charging and discharging with the exception that the cathode active substance was changed to LiCo_{0.999}Ti_{0.001}O₂. After placed in a full-charged state, the battery was loaded in an oven to measure changes in the battery thickness.

### Example B-3

A battery was assembled as in Example B-1 for charging and discharging with the exception that the cathode active substance was changed to LiCo_{0.999}Sn_{0.001}O₂. After placed in a full-charged state, the battery was loaded in an oven to measure changes in the battery thickness.

### Example B-4

A battery was assembled as in Example B-1 for charging and discharging with the exception that the cathode active substance was changed to LiCo_{0.999}Mg_{0.001}O₂. After placed in a full-charged state, the battery was loaded in an oven to measure changes in the battery thickness.

### Example B-5

A battery was assembled as in Example B-1 for charging and discharging with the exception that the cathode active substance was changed to LiCo_{0.9999}Nb_{0.00001}O₂. After placed in a full-charged state, the battery was loaded in an oven to measure changes in the battery thickness.

### Example B-6

A battery was assembled as in Example B-1 for charging and discharging with the exception that the cathode active substance was changed to LiCo_{0.9999}Nb_{0.0001}O₂. After placed in a full-charged state, the battery was loaded in an oven to measure changes in the battery thickness.

### Example B-7

A battery was assembled as in Example B-1 for charging and discharging with the exception that the cathode active substance was changed to LiCo_{0.99}Nbo_{0.01}O₂. After placed in a full-charged state, the battery was loaded in an oven to measure changes in the battery thickness.

### Example B-8

A battery was assembled as in Example B-1 for charging and discharging with the exception that the cathode active substance was changed to LiCo_{0.98}Nb_{0.02}O₂. After placed in a full-charged state, the battery was loaded in an oven to measure changes in the battery thickness.

### Example B-9

A battery was assembled as in Example B-1 for charging and discharging with the exception that the electrolyte solution composition was changed to ethylene carbonate (EC) and γ-butyrolactone at a ratio of 4:6 by volume. After placed in a full-charged state, the battery was loaded in an oven to measure changes in the battery thickness.

### Example B-10

A battery was assembled as in Example B-1 for charging and discharging with the exception that the electrolyte solution composition was changed to ethylene carbonate (EC) and γ-butyrolactone at a ratio of 5:95 by volume. After placed in a full-charged state, the battery was loaded in an oven to measure changes in the battery thickness.

### Comparative Example B-1

A battery was assembled as in Example B-1 for charging and discharging with the exception that the cathode active substance was changed to LiCo_{0.9999}Nb_{0.0001}O₂. After placed in a full-charged state, the battery was loaded in an oven to measure changes in the battery thickness.

### Comparative Example B-2

A battery was assembled as in Example B-1 for charging and discharging with the exception that the cathode active substance was changed to LiCo_{0.9}Nb_{0.1}O₂. After placed in a full-charged state, the battery was loaded in an oven to measure changes in the battery thickness.

### Comparative Example B-3

A battery was assembled as in Example B-1 for charging and discharging with the exception that the electrolyte solution composition was changed to ethylene carbonate (EC) and γ-butyrolactone at a ratio of 5:5 by volume. After placed in a full-charged state, the battery was loaded in an oven to measure changes in the battery thickness.

### Comparative Example B-4

A battery was assembled as in Example B-1 for charging and discharging with the exception that the electrolyte solution composition was changed to γ-butyrolactone=100 by volume. After placed in a full-charged state, the battery was loaded in an oven to measure changes in the battery thickness.

### Comparative Example B-5

A battery was assembled as in Example B-1 for charging and discharging with the exception that the electrolyte solution composition was changed to ethylene carbonate (EC) and diethyl carbonate (DEC) at a ratio of 2:8 by volume. After placed in a full-charged state, the battery was loaded in an oven to measure changes in the battery thickness.

### Comparative Example B-6

A battery was assembled as in Example B-1 for charging and discharging with the exception that the electrolyte solution composition was changed to ethylene carbonate (EC) and methylethyl carbonate (MEC) at a ratio of 2:8 by volume. After placed in a full-charged state, the battery was loaded in an oven to measure changes in the battery thickness.

### Comparative Example B-7

A battery was assembled as in Example B-1 for charging and discharging with the exception that the cathode active substance was changed to LiCo_{0.999}Ti_{0.001}O₂ and the electrolyte solution composition was changed to ethylene carbonate (EC) and methylethyl carbonate (MEC) at a ratio of 2:8 by volume. After placed in a full-charged state, the battery was loaded in an oven to measure changes in the battery thickness.

### Comparative Example B-8

A battery was assembled as in Example B-1 for charging and discharging with the exception that the cathode active substance was changed to LiCo_{0.999}Sn_{0.001}O₂ and the electrolyte solution composition was changed to ethylene carbonate (EC) and methylethyl carbonate (MEC) at a ratio of 2:8 by volume. After placed in a full-charged state, the battery was loaded in an oven to measure changes in the battery thickness.

### Comparative Example B-9

A battery was assembled as in Example B-1 for charging and discharging with the exception that the cathode active substance was changed to LiCo_{0.999}Mg_{0.001}O₂ and the electrolyte solution composition was changed to ethylene carbonate (EC) and methylethyl carbonate (MEC) at a ratio of 2:8 by volume. After placed in a full-charged state, the battery was loaded in an oven to measure changes in the battery thickness.

### Comparative Example B-10

A battery was assembled as in Example B-1 for charging and discharging with the exception that the cathode active substance was changed to LiCoO₂ and the electrolyte solution composition was changed to ethylene carbonate (EC) and γ-butyrolactone at a ratio of 2:8 by volume. After placed in a full-charged state, the battery was loaded in an oven to measure changes in the battery thickness.

The results of these examples are shown in Table 2.

TABLE 2

| | | | | Specific | | | |
|---|---|---|---|---|---|---|---|
| | Substituent | Solvent | 1C Capacity | Capacity | Swelling During Storage at 90° C. | | |
| Sample | Element/at(%) | /volume | (mAh) | −20° C.(%) | 0 | after 30 min. | after 4 hr. |
| Example 1 | Nb/0.1 | EC:γBL/2:8 | 570 | 20 | 4.23 | 4.30 | 4.31 |
| Example 2 | Ti/0.1 | EC:γBL/2:8 | 567 | 18 | 4.25 | 4.29 | 4.30 |
| Example 3 | Sn/0.1 | EC:γBL/2:8 | 566 | 15 | 4.23 | 4.30 | 4.32 |
| Example 4 | Mg/0.1 | EC:γBL/2:8 | 564 | 13 | 4.22 | 4.30 | 4.33 |
| Example 5 | Nb/0.001 | EC:γBL/2:8 | 571 | 12 | 4.20 | 4.23 | 4.23 |
| Example 6 | Nb/0.01 | EC:γBL/2:8 | 571 | 16 | 4.20 | 4.22 | 4.25 |
| Example 7 | Nb/1 | EC:γBL/2:8 | 566 | 16 | 4.21 | 4.22 | 4.26 |
| Example 8 | Nb/2 | EC:γBL/2:8 | 562 | 14 | 4.23 | 4.29 | 4.29 |
| Example 9 | Nb/0.1 | EC:γBL/4:6 | 561 | 15 | 4.24 | 4.27 | 4.28 |
| Example 10 | Nb/0.1 | EC:γBL/5:95 | 565 | 13 | 4.23 | 4.28 | 4.30 |
| Comp. Ex. 1 | Nb/0.0001* | EC:γBL/2:8 | 572 | 8⁺ | 4.21 | 4.25 | 4.26 |
| Comp. Ex. 2 | Nb/10* | EC:γBL/2:8 | 498^{x} | 18 | 4.23 | 4.31 | 4.34 |
| Comp. Ex. 3 | Nb/0.1 | EC:γBL/5:5* | 526^{x} | 17 | 4.25 | 4.29 | 4.30 |
| Comp. Ex. 4 | Nb/0.1 | γBL/100* | 512^{x} | 19 | 4.22 | 4.28 | 4.28 |
| Comp. Ex. 5 | Nb/0.1 | EC:DEC/2:8* | 572 | 13 | 4.23 | 4.32 | 4.55⁺⁺ |
| Comp. Ex. 6 | Nb/0.1 | EC:MEC/2:8* | 574 | 27 | 4.22 | 4.40 | 5.16⁺⁺ |
| Comp. Ex. 7 | Ti/0.1 | EC:MEC/2:8* | 572 | 25 | 4.20 | 4.38 | 4.94⁺⁺ |
| Comp. Ex. 8 | Sn/0.1 | EC:MEC/2:8* | 571 | 20 | 4.24 | 4.37 | 4.88⁺⁺ |
| Comp. Ex. 9 | Mg/0.1 | EC:MEC/2:8* | 571 | 21 | 4.23 | 4.39 | 4.98⁺⁺ |
| Comp. Ex.10 | —* | EC:γBL/2:8 | 566 | 7⁺ | 4.23 | 4.27 | 4.28 |

*deviations from the inventive range
⁺deviations from the allowable range for −20° C. specific capacity
⁺⁺deviations from the allowable range for swelling during storage
^{x}deviations from the allowable range for 1C capacity

From the results of Examples B-1 to B-4 and Comparative Examples B-5 to B-9 shown in Table 2, it is found that even with the cathode active substance to which such additive elements as usually give rise to outgassing are added, it is possible to prevent any outgassing by the use of γ-butyrolactone, and batteries of even smaller size can be fabricated by use of a thin housing. It is here noted that the permissible range of thickness changes is within 0.2 mm.

From Examples B-1 to B-10 and Comparative Examples B-1 to B-10, it is found that the low-temperature properties can be improved by the additive elements. It is here noted that the acceptable specific capacity at—20° C. is at least 10%.

From Examples B-1, B-5, B-6 and B-7 and Comparative Examples B-1, B-2 and B-10, it is appreciated that the addition of the additive element in an amount exceeding 2 at % causes capacity decreases and so is unsuitable for high-capacity batteries. In the inventive examples, the allowable 1 C capacity is at least 550 mAh. On the other hand, the addition of the additive element in an amount of below 0.001 at % brings about specific capacity decreases at low temperature, offering a problem on low-temperature operation.

From Examples B-1, B-9 and B-10 and Comparative Examples B-3 and B-4, it is understood that the proper amount of γ-butyrolactone to be added is in the range of 60 to 95% by volume.

From the foregoing, it is found that the inventive secondary batteries have improved low-temperature properties with no risk of swelling at high temperature. Example C-1

In Example B-1, the binder used in Example A-1 and obtained by the emulsion polymerization process was used for the cathode. Otherwise, a battery was assembled as in Example B-1 for charging and discharging. After placed in a full-charged state, the battery was loaded in an oven to measure changes in the battery thickness. By the same method as in Example A-1, the capacity of the battery was measured. As in Example B-1, no battery swelling was found, and the rate of capacity decreases was on the same low level as in Example A-1.

From the foregoing results, it has been found that by using the binder of Example A-1 and the cathode active substance of Example B-1, effects equivalent to those of both Examples A-1 and B-1 are obtained.

### ADVANTAGES OF THE INVENTION

As detailed above, according to the first embodiment of the invention, it is possible to provide an electrode composition which can reduce capacity decreases experienced when BF salts are used, and a lithium secondary battery.

According to the second embodiment of the invention, it is possible to provide a lithium secondary battery having high discharge capacity even at low temperature and unlikely to swell even during storage.

What is claimed is:

1. An electrode composition containing a lithium fluoroborate-based salt in an electrolyte, wherein:
a poly(vinylidene fluoride) homopolymer is contained at least as a binder and a lactone is contained as an electrolyte solvent,
said poly(vinylidene fluoride) homopolymer being obtained by a emulsion polymerization process.

2. The electrode composition according to claim 1, wherein said poly(vinylidene fluoride) homopolymer has a molecular weight of 50,000 or higher and a degree of crystallinity of 30% or greater, and
a solvent for an electrolyte solution further contains a cyclic carbonate provided that the volume ratio of said cyclic carbonate and said lactone is in the range of 3/7 to 1/9 as calculated on an ethylene carbonate-to-γ-butyrolactone basis.

3. A lithium secondary battery, which comprises an electrode composition as recited in claim 1 or 2.

4. The lithium secondary battery according to claim 3, wherein at least the poly(vinylidene fluoride) homopolymer, lactone and lithium fluoroborate-based salt are contained as solid electrolyte components.

5. The lithium secondary battery according to claim 3 or 4, wherein a lithium-containing composite oxide comprising lithium cobalt oxide and a subordinate component element M, where M is a transition or typical metal element exclusive of Li and Co, in an amount of 0.001 to 2 at % relative to cobalt in the lithium cobalt oxide is contained as a cathode active substance, and 60 to 95% by volume of γ-butyrolactone is contained as an electrolyte solvent.

6. The lithium secondary battery according to claim 5, wherein said subordinate component element is one or two or more of Ti, Nb, Sn and Mg.

7. A lithium secondary battery, wherein:
a cathode, an anode and an electrolyte are encased in a housing,
a lithium-containing composite oxide comprising lithium cobalt oxide and a subordinate component element M, where M is a transition or typical metal element exclusive of Li and Co, in an amount of 0.001 to 2 at % relative to cobalt in the lithium cobalt oxide is contained as a cathode active substance,
60 to 95% by volume of γ-butyrolactone is contained as an electrolyte solvent, and
said housing has a thickness of 0.3 mm or smaller.

8. The lithium secondary battery according to claim 7, wherein said subordinate component element is one or two or more of Ti, Nb, Sn and Mg.
